(19) United States
(12) Patent Application Publication
(10) Pub. No.: US 2009/0158376 A1
(43) Pub. Date: Jun. 18, 2009

(54) METHOD AND APPARATUS OF BUILDING IP-BASED VIDEO SERVICE SYSTEM IN HYBRID FIBER COAX NETWORK

(76) Inventors: Seung Eun HONG, Daejeon (KR); O Hyung KWON, Daejeon (KR); Soo In LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/325,371

(22) Filed: Dec. 1, 2008

(30) Foreign Application Priority Data
Dec. 17, 2007 (KR) 10-2007-0132458

(51) Int. Cl. H04N 7/173

(52) U.S. Cl. 725/116

(57) ABSTRACT

An apparatus and method of building an Internet Protocol (IP)-based video service system in a Hybrid Fiber Coax (HFC) network is provided. An apparatus for building an IP-based video service providing system, the apparatus including: an IP decapsulation unit to delete a header in a video signal in a packet form transmitted by an IP-based video server, and to subsequently transmit the video signal to a headend; the headend to encapsulate the video signal received by the IP decapsulation unit into a Media Access Control (MAC) header, and to transmit the encapsulated video signal in the packet form; and an IP protocol encapsulation unit to perform IP encapsulation of the video signal received from the headend.

### CROSS-REFERENCE TO RELATED APPLICATION

This application claims priority from Korean Patent Application No. 10-2007-0132458, filed on Dec. 17, 2007, in the Korean Intellectual Property Office, the entire disclosure of which is incorporated herein by reference.

### BACKGROUND OF THE INVENTION

1. Field of the Invention

The present invention relates to a video service providing method, and more particularly, to an apparatus and method of building an Internet Protocol (IP)-based video service system in a Hybrid Fiber Coax (HFC) network.

This work was supported by the IT R&D program of MIC/IITA [2006-S-019-02, The Development of Digital Cable Transmission and Receive System for 1 Gbps Downstream].

2. Description of Related Art

Since a form of a legacy broadcasting service changes from a broadcasting form provided for many users over a broad area to a broadcasting/communication-integrated service in a narrowcasting form of broadcasting for a confined area, cable operators of a Hybrid Fiber Coax (HFC) network developed a Switched Digital Video (SDV) service for efficiently using a predetermined resource.

Internet Protocol Television (IPTV) systems for providing an Internet Protocol (IP)-based video service that enables resource-efficiency using a video program switching concept such as an SDV, and various other viewing forms for televiewers have been developed.

However, since the current cable-based IPTV systems using the HFC network perform IP encapsulation of video traffic in a headend and transmit a video. which is transformed into the IP protocol through the HFC network to a general-purpose IPTV set top box using an IP set top box or a cable modem (CM), scarce network resources are lost to overhead caused by the addition of IP or IP/User Datagram Protocol (UDP) or IP/UDP/Real-time Transport Protocol (RTP) header information due to transformation into the IP protocol.

### SUMMARY OF THE INVENTION

An aspect of the present invention provides a method of performing Internet Protocol (IP) encapsulation in a subscriber apparatus including a cable modem (CM) without performing the IP encapsulation in a headend of a Hybrid Fiber Coax (HFC) network. For example, since a video may be watched in only a video output apparatus connected with a cable set top box when transmitting a Motion Picture Experts Group (MPEG)-based video to a video channel, various televiewing forms of users may not be provided. Overhead caused by the IP encapsulation when transmitting an IP-based video to a Data Over Cable Service Interface Specifications (DOCSIS) channel may waste scarce resources of the HFC network using the ubiquitous IP protocol and an address system in order to support various viewing forms of users and to provide a multicast service of only a request program.

A DOCSIS protocol supports a Payload Header Suppression (PHS) scheme in order to reduce the overhead based on the IP encapsulation, however, since embodiment complexity increases based on the PHS scheme, and a timestamp of a Real-time Transport Protocol (RTP) uniquely changes based on a characteristic of the PHS scheme, PHS application may be difficult. Current DOCSIS protocol standards do not support RTP PHS.

Another aspect of the present invention also provides a method of eliminating an IP-encapsulated portion in a headend, transmitting a video signal to a subscriber apparatus, and performing IP encapsulation in the subscriber apparatus even when the video signal arrives at the headend already having been IP-encapsulated at an Internet Protocol Television (IPTV) source.

According to an aspect of the present invention, there is provided an apparatus for building an IP-based video service providing system, the apparatus including: an IP decapsulation unit to delete a header in a video signal in a packet form transmitted by an IP-based video server, and to subsequently transmit the video signal to a headend; the headend to encapsulate the video signal received by the IP decapsulation unit into a Media Access Control (MAC) header, and to transmit the encapsulated video signal in the packet form; and an IP protocol encapsulation unit to perform IP encapsulation of the video signal received from the headend.

According to another aspect of the present invention, there is provided a method of building an IP-based video service system, the method including: transmitting, by an IP protocol-based video server, a video packet using a specific protocol; transmitting the video packet to a headend after an IP decapsulation block having received the video packet deletes a header; encapsulating by the headend, the video packet into a MAC header, and transmitting the encapsulated video packet to a CM in an MPEG packet form; and transmitting, by the CM having received the transmitted video packet in the packet form, the video packet to an IP encapsulation block, and performing IP encapsulation.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 illustrates a configuration of a system for providing an Internet Protocol (IP)-based video service in a Hybrid Fiber Coax (HFC) network according to an exemplary embodiment of the present invention;

FIG. 2 is a diagram illustrating a Motion Picture Experts Group (MPEG) packet format transmitted via a video channel according to an exemplary embodiment of the present invention;

FIG. 3 is a diagram illustrating an MPEG packet format transmitted via a Data Over Cable Service Interface Specifications (DOCSIS) channel according to an exemplary embodiment of the present invention; and

FIG. 4 is a diagram illustrating a video packet format included in an MPEG packet transmitted to a DOCSIS channel according to an exemplary embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

When detailed descriptions related to a well-known related function or configuration are determined to make the spirits of the present invention ambiguous, the detailed descriptions will be omitted herein. Also, terms used throughout the present specification are used to appropriately describe exemplary embodiments of the present invention, and thus may be different depending upon a user and an operator's intention, or practices of application fields of the present invention. Therefore, the terms must be defined based on descriptions made through the present invention.

Since a form of a legacy broadcasting service changes from a broadcasting form provided for many users over a broad area to a broadcasting/communication-integrated service in a narrowcasting form of broadcasting for a confined area, cable operators of a Hybrid Fiber Coax (HFC) network developed a Switched Digital Video (SDV) service for efficiently using a predetermined resource. However, the SDV service enables televiewers to view broadcasting contents using only a cable set top box.

Internet Protocol Television (IPTV) systems for providing an Internet Protocol (IP)-based video service that enables resource-efficiency using a video program switching concept such as an SDV and various viewing forms of televiewers have been recently developed. The current cable-based IPTV systems using the HFC network perform IP encapsulation of video traffic in a headend and transmit a video, which is transformed into the IP protocol, through the HFC network to a general-purpose IPTV set top box using an IP set top box or a cable modem (CM).

Since IP or IP/User Datagram Protocol (UDP) or IP/UDP/Real-time Transport Protocol (RTP) header information is added due to transformation into the IP protocol, the cable-based IPTV system causes much overhead, thereby losing scarce network resources.

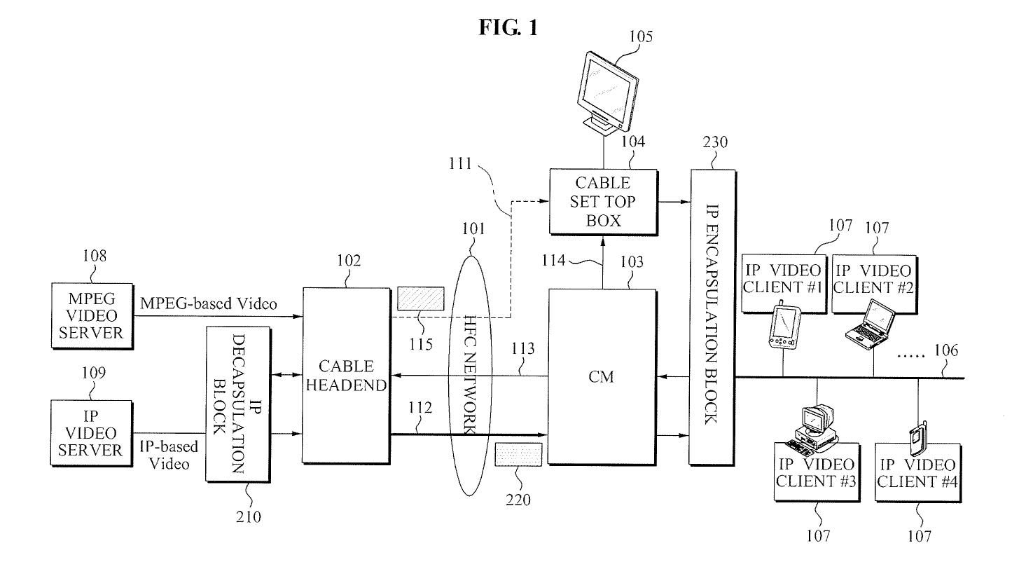

FIG. 1 illustrates a configuration of a system for providing an IP-based video service in an HFC network according to an exemplary embodiment of the present invention.

The system for providing the IP-based video service in the HFC network according to an exemplary embodiment of the present invention includes an HFC network 101, a cable headend 102, a CM 103, a cable set top box 104, a Customer Premises Equipment (CPE)-interface 106 (hereinafter referred to as CMCI), CPE hosts 107, a Motion Picture Experts Group (MPEG) video server 108, an IP video server 109, IP encapsulation, a downstream channel (a video channel 111 and a Data Over Cable Service Interface Specifications (DOCSIS) channel 112), an upstream channel 113, an IP decapsulation block 210, an IP encapsulation block 230, and the like, and the exemplary embodiment of the present invention is described below.

The HFC network 101 connects the cable headend 102 with a plurality of CMs 103 or the cable set top box 104 using the downstream channel (the video channel 111 and the DOCSIS channel 112) and the upstream channel 113, and the cable set top box 104 may include the built-in CM 103 and may be directly connected with the HFC network.

The headend 102 may receive an MPEG-based video packet from the MPEG video server 108, and may receive an IP-based video packet from the IP video server 109. When the IP-based video packet is received, the headend 102 encapsulates the video packet into a DOCSIS Media Access Control (MAC) frame, performs MPEG packetization again, and transmits the video packet to the HFC network 101 using the DOCSIS channel 112. When the MPEG-based video packet is received, the headend transmits the video packet to the HFC network 101 using the video channel 111. Currently, the MPEG-based video packet may be transmitted to the DOCSIS channel 112 using the headend 102 after performing the IP encapsulation of the MPEG-based video packet in order to effectively use a resource of the HFC network 101.

The CM 103 receives the DOCSIS MAC frame received from the HFC network 101 to the DOCSIS channel 112, and outputs an Ethernet packet included in the DOCSIS MAC frame to the CMCI 106. The CMCI 106 is an interface to connect the CPE hosts 107 with the CM 103, and the CPE hosts 107 are referred to as IP video clients #1, #2, #3, and #4 in the present invention.

The cable set top box 104 processes a video signal received from the video channel 111 being provided by the HFC network 101 or a video signal 114 received from the CM 103 using the DOCSIS channel 112, and outputs the processed video signal to a video output apparatus 105.

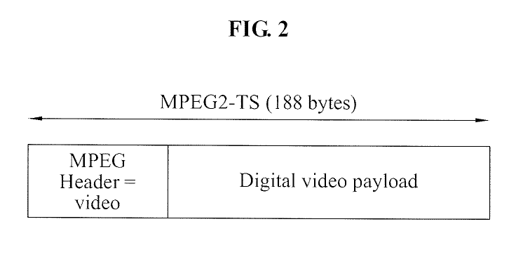

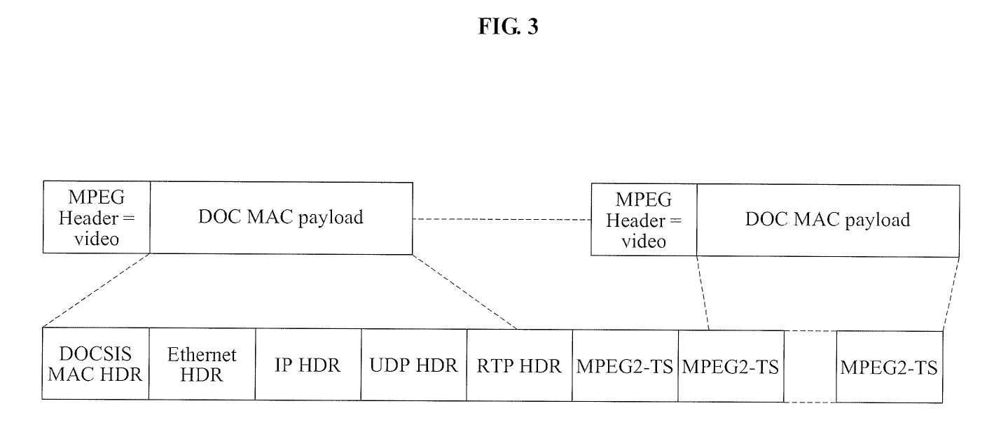

A packet form transmitted to the video channel 111 for a general video service and a packet form transmitted to the DOCSIS channel 112 are respectively illustrated in FIG. 2 and FIG. 3.

FIG. 2 is a diagram illustrating an MPEG packet form transmitted to the video channel 111 according to an exemplary embodiment of the present invention, and FIG. 3 is a diagram illustrating an MPEG packet form transmitted to the DOCSIS channel 112 according to an exemplary embodiment of the present invention.

Hereinafter, referring to FIG. 2 and FIG. 3, MPEG packets transmitted to the video channel 111 and the DOCSIS channel 112 according to an exemplary embodiment of the present invention are described.

As illustrated in FIG. 2 and FIG. 3, both the MPEG packet transmitted to the video channel 111 and the MPEG packet transmitted to the DOCSIS channel 112 include 188 bytes, and each packet starts at an MPEG header of 4-byte length and a 184-byte payload.

TABLE 1
MPEG2-Transport Stream (TS) packet header configuration

| Field | Bits | Description |
|---|---|---|
| Sync_byte | 8 | 0x47; MPEG Packet Sync byte |
| transport_error_indicator | 1 | Indicates that an error has occurred |
| (TEI) | | in the reception of the packet. |
| payload_unit_start_indicator | 1 | A value of one indicates the |
| (PUSI) | | presence of a pointer_field as |
| | | the first byte of the payload |
| | | (fifth byte of the packet) |
| transport_priority | 1 | Reserved; set to zero |
| Packet Identifier (PID) | 13 | DOCSIS Data-Over-Cable |
| | | well-known PID (0x1FFE) |
| transport_scrambling_control | 2 | Reserved, set to ‘00’ |
| adaptation_field_control | 2 | ‘01’; use of the adaptation_field |
| | | is not allowed on the DOCSIS PID |
| continuity_counter (CC) | 4 | cyclic counter within this PID |

The MPEG header is illustrated in Table 1. The two MPEG packets are classified by a PID field value of the MPEG header, and the MPEG packet transmitted to the DOCSIS channel 112 always includes a PID value of 0x1FFE.

The MPEG packet transmitted to the video channel 111 loads a video signal in a payload portion of 184 bytes, and the MPEG packet transmitted to the DOCSIS channel 112 may include an optional one-byte pointer_field in a 184-byte payload portion, and loads a DOCSIS MAC payload of 183 bytes or 184 bytes. The DOCSIS MAC payload may load a portion of a DOCSIS MAC frame or at least one DOCSIS MAC frame. The DOCSIS MAC frame is composed by encapsulating the Ethernet packet into a DOCSIS MAC header.

The present invention considers only a case where the Ethernet packet includes the video signal. Accordingly, the Ethernet packet generally includes an Ethernet header, an IP header, a UDP header, an optional RTP header, and a plurality of MPEG2 TS packets. A number of MPEG2 TS packets included in the Ethernet packet is determined based on a maximum length of the Ethernet packet.

A UDP denotes a User Datagram Protocol, and is a communication protocol by which a transmitter transmits data unilaterally without passing through a signal process of transmitting or receiving information when transceiving the information with each other on the Internet. The UDP denotes a protocol generated to enable the transmitter not to verify whether or not a receiver receives the data, and not to need to verify whether or not the receiver receives the data.

The UDP is a contrary concept to a Transmission Control Protocol (TCP) being a communication protocol designed to enable a client terminal or a computer to be automatically connected with a center computer server simultaneously with pressing an Internet icon, and to enable the transmitter and the receiver of the information to communicate with each other. For example, knowing whether or not a counterpart reads a mail using ‘receiving ascertainment’ when transceiving an email is caused by a fact that the transmitter and the receiver may transceive the data with each other.

As described above, a scheme by which the transmitter and the receiver transceive the data with each other is the TCP, and a scheme by which the transmitter transmits the data regardless of a fact that the receiver watches the data is the UDP. The UDP is a scheme by which the transmitter transmits the data unilaterally without passing through an access process to the receiver, and this service is referred to as a non-relation service, and a communication protocol of the non-relation service is the UDP.

Accordingly, the UDP is not responsible for receiving the data, different from the TCP. This denotes that the transmitter transmits the information and needs to participate in whether the information arrives at the receiver at a proper time or information contents are switched. The UDP is less stable than the TCP, however, the UDP is even quicker than the TCP.

Generally, since a video may be watched in only a video output apparatus connected with a cable set top box when transmitting an MPEG-based video to the video channel, various viewing forms of users may not be provided. Overhead based on IP encapsulation when transmitting an IP-based video to the DOCSIS channel may waste a precious resource of the HFC network using universality of the IP protocol and an address system in order to support the various viewing forms of users and to provide a multicast service of only a request program. A DOCSIS protocol supports a Payload Header Suppression (PHS) scheme in order to reduce the overhead based on the IP encapsulation, however, since embodiment complexity increases based on the PHS scheme and a timestamp of an RTP particularly changes based on a characteristic of the PHS scheme, PHS application may be difficult. A current DOCSIS protocol standard does not support RTP PHS.

Accordingly, a system for providing the IP-based video service in the HFC network illustrated in FIG. 1 is disclosed in order to solve the above-described problem.

First, a headend does not perform the IP encapsulation, and deletes headers used for the IP encapsulation when IP-based video traffic is inputted. The IP decapsulation block 210 may delete only an RTP header in the case of RTP-based video traffic, or may optionally delete a UDP header and an IP header. Since the headend acquires flow information to be transmitted to the HFC network in advance, a plurality of header information needing to be deleted being classified by a flow may be classified.

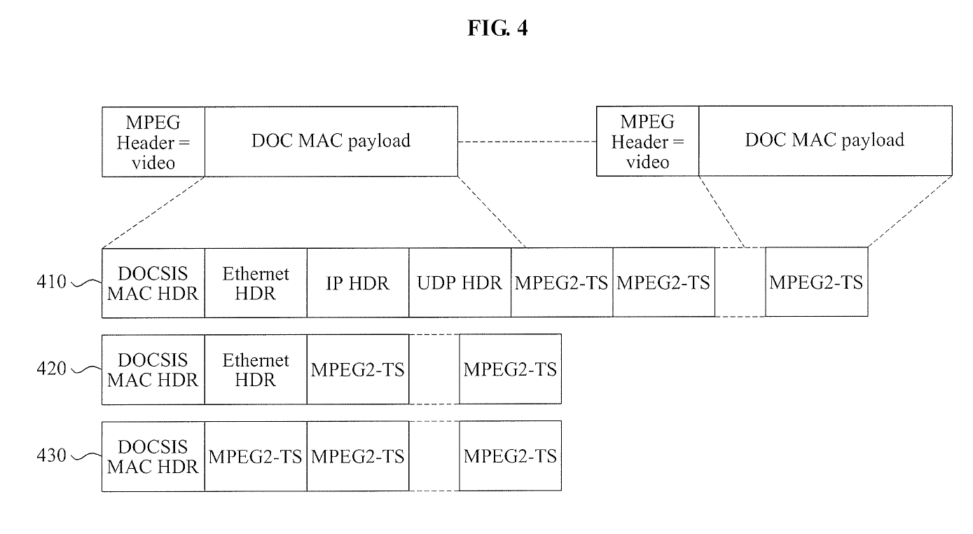

Video traffic 115 transmitted to the video channel 11 using the headend is the same as FIG. 2, however, traffic 220 transmitted to the DOCSIS channel 112 is different from FIG. 3 due to the headers deleted by the IP decapsulation block 210. A form of the traffic 220 transmitted to the DOCSIS channel 112 is described in detail with reference to FIG. 4.

The cable set top box 104 receiving the video traffic using the video channel 111 or/and the CM 103 receiving the IP-decapsulated video traffic using the DOCSIS channel 112 transmits/transmit the video signal to the IP encapsulation block 230, and the IP encapsulation block 230 performs IP encapsulation of the received video signal. As described above, the received video signal is transformed into the IP protocol by adding the IP encapsulation block 230 to a subscriber apparatus including the CM 103 and/or the cable set top box 104, and the video signal being transformed into the IP protocol is transmitted to IP-based video clients, thereby enabling various viewing for users.

The IP encapsulation block 230 of the subscriber apparatus may acquire a plurality of information required or transformation into the IP protocol by monitoring the packets coming from the CPE hosts including a public IP address into the CM 103 even though this is not described in detail in the present specification. When the IP encapsulation block 230 of the subscriber apparatus provides a service for the CPE hosts including a private IP address, the IP encapsulation block 230 of the subscriber apparatus may perform a conversion function between individual private IP addresses and a general public IP address, may perform the IP encapsulation of video signals, and may perform a function of transmitting the IP-encapsulated video signals to the CPE hosts.

As described above, since the IP encapsulation in the headend is eliminated, the overhead based on the transformation into the IP protocol is eliminated in the IP-based video traffic, and the transformation into the IP protocol is performed in the subscriber apparatus, the overhead in the HFC network may be minimized.

FIG. 4 is a diagram illustrating a video packet form included in an MPEG packet transmitted to a DOCSIS channel according to an exemplary embodiment of the present invention.

Hereinafter, referring to FIG. 4, the video packet form included in the MPEG packet transmitted to the DOCSIS channel according to an exemplary embodiment of the present invention is described.

First, an MPEG packet form is the same as FIG. 3, that is, the MPEG packet form of 188 bytes, and includes an MPEG header of 4 bytes and a payload of 184 bytes. An optional one-byte pointer field may exist in a payload portion of 184 bytes, and a DOCSIS MAC payload of 183 bytes or 184 bytes is loaded. A portion of a DOCSIS MAC frame or at least one DOCSIS MAC frame may be loaded in the DOCSIS MAC payload.

According to an exemplary embodiment of the present invention, a method of encapsulating an IP-based video packet into the DOCSIS MAC flame and transmitting the encapsulated video packet to a DOCSIS channel of an HFC network may be represented as diagrams 410, 420, and 430.

When transmitting the video packet using a method such as diagram 410, the IP-based video server 109 transmits the video packet using an RTP protocol. A video signal of an MPEG2-TS packet form is sequentially encapsulated into an Ethernet header, an IP header, a UDP header, and an RTP header, and comes into a headend, and the IP decapsulation block 210 deletes the RTP header and subsequently transmits the video signal of the MPEG2-TS packet form to the headend 102, and the headend 102 encapsulates the video signal of the MPEG2-TS packet form into a DOCSIS MAC header and transmits the video signal of the MPEG2-TS packet form to the MPEG packet. The constructed DOCSIS MAC frame is illustrated in diagram 410, and the IP header and the UDP header may be suppressed by PHS even though this is not illustrated in FIG. 4. As described above, since a time stamp value of the RTP header constantly changes, reducing overhead by applying the PHS is difficult. Accordingly, the IP decapsulation block 210 deletes the RTP header. The RTP header being deleted as described above needs to be reconstructed in the IP encapsulation block 230. A specific process of reconstructing the RTP header in the IP encapsulation block 230 is omitted in the present specification. Various methods may be applied to a reconstruction process of the RTP header, however, the reconstruction process of the RTP header generally follows a method of transforming the MPEG packet into an RTP packet (Request For Comments (RFC) 2250).

An RTP is prescribed along with an RTP control protocol (RTCP) in a transport layer communication protocol for transceiving a voice or a call in real time, that is, RFC 1889. The RTP is characteristically executed among terminals without depending on a network device including a router and the like, different from a Resource Reservation Protocol (RSVP).

The RTP is generally used for an upper communication protocol of a UDP. A transmitter may select replaying synchronization based on a time stamp and abandon a packet including long delay. A receiver may inspect transmission delay, a bandwidth, and the like, may adjust an encoding speed and the like by reporting the transmission delay, the bandwidth, and the like to an upper-layer application of the transmitter using the RTCP, and may embody Quality of Service (QoS) control. The RTP was adopted for International Telecommunication Union-Telecommunication Standardization Sector (ITU-T) recommendation H.323 with respect to a video conference system in a local area network (LAN)/Internet environment, and a video conference program NetMeeting of a Microsoft Corporation of U.S. and the like are installed.

When transmitting the video packet using a method such as diagram 420, the IP-based video server 109 transmits the video packet using the RTP protocol or using only the IP/UDP protocol, and the IP decapsulation block 210 deletes the IP header, the UDP header, or/and the RTP header. IP encapsulation headers deleted by the IP decapsulation block 210 need to be capable of being reconstructed by the IP encapsulation block 230. The IP encapsulation block 230 may utilize service flow information connected with the headend 102 with the CM 103 or the cable set top box 104. For this, the headend 102 may write the related service flow information in the DOCSIS MAC header.

When transmitting the video packet using a method such as diagram 430, the IP-based video server 109 transmits the video packet using the RTP protocol or using only the IP/UDP protocol, and the IP decapsulation block 210 deletes the Ethernet header, the IP header, the UDP header, or/and the RTP header. The IP encapsulation headers deleted by the IP decapsulation block 210 need to be capable of being reconstructed by the IP encapsulation block 230. The IP encapsulation block 230 may utilize the service flow information connected with the headend 102 with the CM 103 or the cable set top box 104. For this, the headend 102 may write the related service flow information in the DOCSIS MAC header.

The method of building the IP-based video service system in the HFC network according to the above-described exemplary embodiments may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to the present invention, it is possible to transmit a video signal to any IP video output apparatus using universality of an IP protocol and an address system by performing IP encapsulation in a subscriber apparatus including a CM, and to support various viewing forms of users.

Also, according to the present invention, it is possible that a support protocol is simple and overhead based on IP encapsulation does not exist since a video signal is transmitted to an HFC network without the IP encapsulation, and it is possible to be efficient for network resource use by restoring the video signal in a subscriber apparatus.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for building an Internet Protocol (IP)-based video service providing system, the apparatus comprising:
an IP decapsulation unit to delete a header in a video signal in a packet form transmitted by an IP-based video server, and to subsequently transmit the video signal to a headend;
the headend to encapsulate the video signal received by the IP decapsulation unit into a Media Access Control (MAC) header, and to transmit the encapsulated video signal in the packet form; and
an IP protocol encapsulation unit to perform IP encapsulation of the video signal received from the headend.

2. The apparatus of claim 1 further comprising:
a cable modem (CM) to receive IP-decapsulated video traffic transmitted by the headend, and to transmit the received video traffic to the IP protocol encapsulation unit.

3. The apparatus of claim 1, further comprising:
the IP-based video server to transmit a video packet using a predetermined protocol.

4. The apparatus of claim 1, further comprising:
the video server to transmit the Motion Picture Experts Group (MPEG)-based video signal.

5. The apparatus of claim 1, further comprising:
a cable set top box to process the video signal received using a specific channel or the video signal received using a CM, and to output the processed video signal to a video output apparatus.

6. The apparatus of claim 1, wherein the IP decapsulation unit deletes any one of a Real-time Transport Protocol (RTP) header, a user datagram protocol header, and an IP header.

7. The apparatus of claim 1, wherein the headend acquires flow information to be transmitted to a Hybrid Fiber Coax (HFC) network in advance, and classifies a plurality of header information to be deleted being classified by a flow.

8. The apparatus of claim 1, wherein the IP encapsulation unit receives the video signal from a CM, performs the IP encapsulation of the received video signal, and provides Customer Premises Equipment (CPE) hosts with the IP-encapsulated video signal.

9. The apparatus of claim 8, further comprising:
a function to acquire a plurality of information required for transformation into the IP protocol by monitoring packets coming from the CPE hosts including a public IP address into a CM.

10. The apparatus of claim 8, further comprising:
a conversion function between private IP addresses and a general public IP address.

11. A method of building an IP-based video service system, the method comprising:
transmitting, by an IP protocol-based video server, a video packet using a specific protocol;
transmitting the video packet to a headend after an IP decapsulation block having received the video packet deletes a header;
encapsulating, by the headend, the video packet into a MAC header, and transmitting the encapsulated video packet to a CM in an MPEG packet form; and
transmitting, by the CM having received the transmitted video packet in the packet form, the video packet to an IP encapsulation block, and performing IP encapsulation.
